(19) United States
(12) Patent Application Publication
(10) Pub. No.: US 2014/0358741 A1
(43) Pub. Date: Dec. 4, 2014

(54) METHOD AND SYSTEM FOR SHOWROOMING DETECTION

(71) Applicant: MasterCard International Incorporated, Purchase, NY (US)

(72) Inventor: Justin X. HOWE, Oakdale, NY (US)

(21) Appl. No.: 13/904,733

(22) Filed: May 29, 2013

(51) Int. Cl. G06Q 30/02; G06Q 40/00

(52) U.S. Cl. CPC G06Q 30/0201; G06Q 40/12
USPC 705/30

(57) ABSTRACT

A method for identifying instances of showrooming includes: storing a plurality of location data entries, each location data entry including a geographic location and location timestamp; storing a plurality of transaction data entries, each transaction data entry including a merchant identifier and transaction timestamp; identifying at least one matched data entry including a location data entry and a transaction data entry where the location timestamp is within a predefined range of time that includes the transaction timestamp; identifying, for each matched data entry, at least one nearby merchant based on the geographic location included in the corresponding location data entry; identifying a specific matched data entry of the at least one matched data entry indicating showrooming where the merchant identifier included in the corresponding transaction data entry is not associated with any of the corresponding at least one nearby merchant; and storing the identified specific matched data entry.

### FIELD

The present disclosure relates to the detection of showrooming transactions, specifically the use of transaction and location information to detect instances of showrooming by consumers.

### BACKGROUND

The ability for consumers to conduct financial transactions on the Internet has enabled consumers around the world to purchase products from the comfort of their own home. However, many consumers may often times desire to see a product in person before making a purchase, such as to be assured of quality, color, size, etc. In some instances, a consumer may visit a storefront of a merchant to view a product, but then purchase the product online from a different retailer that may offer the product at a lower price, or with some other incentive, in a process known in the industry as “showrooming.”

With the increased Internet accessibility of mobile devices, such as smartphones, merchants can be at an even greater risk of being taken advantage of via showrooming. Traditionally, a consumer would have had to leave the merchant's storefront to access a computing device capable of ordering the showroomed product. The extra time necessary to get to a computing device may have served as a deterrent to some consumers to showroom; the consumer may instead decide to purchase the product from the merchant out of convenience. However, consumers with smart phones are able to search for a variety of retailers selling a desired product while still at the merchant storefront, locate a retailer, and purchase the product, without the inconvenience of having to leave and find a computing device to use. The result is that merchants are more likely to be victims of showrooming, which leads to a decrease in revenue, which can prohibit lowering of prices, which can further encourage showrooming, etc.

Merchants who are victims of showrooming are often unable to identify the characteristics of a showrooming consumer or transaction, or in some instances even identify that showrooming has occurred at all. As a result, these merchants are often unable to develop methods to mitigate the adverse effects of showrooming, such as by enticing consumers likely to showroom, or pricing at-risk products more competitively. Thus, there is a need for a technical solution to provide identification of instances of showrooming.

### SUMMARY

The present disclosure provides a description of systems and methods for identifying instances of showrooming and identifying the characteristics of showrooming consumers.

A method for identifying instances of showrooming includes: storing, in a location database, a plurality of location data entries, wherein each location data entry includes data related to a location of a mobile device associated with a consumer including at least a geographic location and a location timestamp; storing, in a transaction database, a plurality of transaction data entries, wherein each transaction data entry includes data related to a financial transaction involving the consumer including at least a merchant identifier and a transaction timestamp; identifying, by a processing device, at least one matched data entry including a location data entry and a transaction data entry where the location timestamp in the location data entry is within a predefined range of time that includes the transaction timestamp in the transaction data entry; identifying, for each of the at least one matched data entry, at least one nearby merchant based on the geographic location included in the corresponding location data entry; identifying, by the processing device, a specific matched data entry of the at least one matched data entry indicating showrooming where the merchant identifier included in the corresponding transaction data entry is not associated with any of the corresponding at least one nearby merchant; and storing, in a showrooming database, the identified specific matched data entry.

A method for identifying characteristics of showrooming consumers includes: storing, in a consumer database, a plurality of consumer data entries, wherein each consumer data entry includes data relating to a consumer including at least demographic information and an account identifier associated with a payment account associated with the related consumer; storing, in a transaction database, a plurality of transaction data entries, wherein each transaction data entry includes data relating to a financial transaction that indicates showrooming including at least an account identifier associated with a payment account involved in the financial transaction, a transaction time, a geographic location at the transaction time of a mobile device associated with the consumer associated with the payment account involved in the financial transaction, and a merchant identifier associated with a merchant involved in the financial transaction, and wherein the geographic location identifies the mobile device in a location not associated with the merchant involved in the financial transaction; receiving, by a receiving device, a request for characteristic data, wherein the request includes at least a geographic location; identifying, in the transaction database, a subset of the plurality of transaction data entries where the included geographic location corresponds to the geographic location included in the received request; identifying, in the consumer database, at least one consumer data entry where the account identifier included in each of the at least one consumer data entry corresponds to the account identifier included in at least one of the transaction data entries in the subset of the plurality of transaction data entries; generating, by a processing device, a report based on the demographic information included in the identified at least one consumer data entry; and transmitting, by a transmitting device, the generated report in response to the request for characteristic data, wherein the demographic information does not include personally identifiable information.

A system for identifying instances of showrooming includes a showroom database, a location database, a transaction database, and a processing device. The location database is configured to store a plurality of location data entries, wherein each location data entry includes data related to a location of a mobile device associated with a consumer including at least a geographic location and a location timestamp. The transaction database is configured to store a plurality of transaction data entries, wherein each transaction data entry includes data related to a financial transaction involving the consumer including at least a merchant identifier and a transaction timestamp. The processing device is configured to: identify at least one matched data entry including a location data entry and a transaction data entry where the location timestamp in the location data entry is within a predetermined range of time that includes the transaction timestamp in the transaction data entry; identify, for each of the at least one matched data entry, at least one nearby merchant based on the geographic location included in the corresponding location data entry; identify a specific matched data entry of the at least one matched data entry indicating showrooming where the merchant identifier included in the corresponding transaction data entry is not associated with any of the corresponding at least one nearby merchant; and store, in the showrooming database, the identified specific matched data entry.

A system for identifying characteristics of showrooming consumers includes a consumer database, a transaction database, a receiving device, and a transmitting device. The consumer database is configured to store a plurality of consumer data entries, wherein each consumer data entry includes data relating to a consumer including at least demographic information and an account identifier associated with a payment account associated with the related consumer. The transaction database is configured to store a plurality of transaction data entries, wherein each transaction data entry includes data relating to a financial transaction that indicates showrooming including at least an account identifier associated with a payment account involved in the financial transaction, a transaction time, a geographic location at the transaction time of a mobile device associated with the consumer associated with the payment account involved in the financial transaction, and a merchant identifier associated with a merchant involved in the financial transaction, and wherein the geographic location identifies the mobile device in a location not associated with the merchant involved in the financial transaction. The receiving device is configured to receive a request for characteristic data, wherein the request includes at least a geographic location. The processing device configured to: identify, in the transaction database, a subset of the plurality of transaction data entries where the included geographic location corresponds to the geographic location included in the received request; identify, in the consumer database, at least one consumer data entry where the account identifier included in each of the at least one consumer data entry corresponds to the account identifier included in at least one of the transaction data entries in the subset of the plurality of transaction data entries; and generate a report based on the demographic information included in the identified at least one consumer data entry. The transmitting device is configured to transmit the generated report in response to the request for characteristic data, wherein the demographic information does not include personally identifiable information.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for the identifying of instances of showrooming and the characteristics of showrooming consumers in accordance with exemplary embodiments.

FIG. 2 is a block diagram illustrating the processing server of FIG. 1 for the identification of instances of showrooming in accordance with exemplary embodiments.

FIG. 3 is a block diagram illustrating the transaction database of the processing server of FIG. 2 in accordance with exemplary embodiments.

FIG. 4 is a flow diagram illustrating a method for identifying instances of showrooming in accordance with exemplary embodiments.

FIGS. 5A and 5B are diagrams illustrating the identification of showrooming via location and transaction data in accordance with exemplary embodiments.

FIG. 6 is a flow chart illustrating an exemplary method for the identification of instances of showrooming in accordance with exemplary embodiments.

FIG. 7 is a flow chart illustrating an exemplary method for identifying characteristics of showrooming consumers in accordance with exemplary embodiments.

FIG. 8 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, etc.

Personally identifiable information (PII)—PII may include information that may be used, alone or in conjunction with other sources, to uniquely identify a single individual. Information that may be considered personally identifiable may be defined by a third party, such as a governmental agency (e.g., the U.S. Federal Trade Commission, the European Commission, etc.), a non-governmental organization (e.g., the Electronic Frontier Foundation), industry custom, consumers (e.g., through consumer surveys, contracts, etc.), codified laws, regulations, or statutes, etc. The present disclosure provides for methods and systems where the processing server 114, discussed in more detail below, does not possess any personally identifiable information. Systems and methods apparent to persons having skill in the art for rendering potentially personally identifiable information anonymous may be used, such as bucketing. Bucketing may include aggregating information that may otherwise be personally identifiable (e.g., age, income, etc.) into a bucket (e.g., grouping) in order to render the information not personally identifiable. For example, a consumer of age 26 with an income of $65,000, which may otherwise be unique in a particular circumstance to that consumer, may be represented by an age bucket for ages 21-30 and an income bucket for incomes $50,000 to $74,999, which may represent a large portion of additional consumers and thus no longer be personally identifiable to that consumer. In other embodiments, encryption may be used. For example, personally identifiable information (e.g., an account number) may be encrypted (e.g., using a one-way encryption) such that the processing server 114 may not possess the PII or be able to decrypt the encrypted PII.

### System for Showrooming Detection

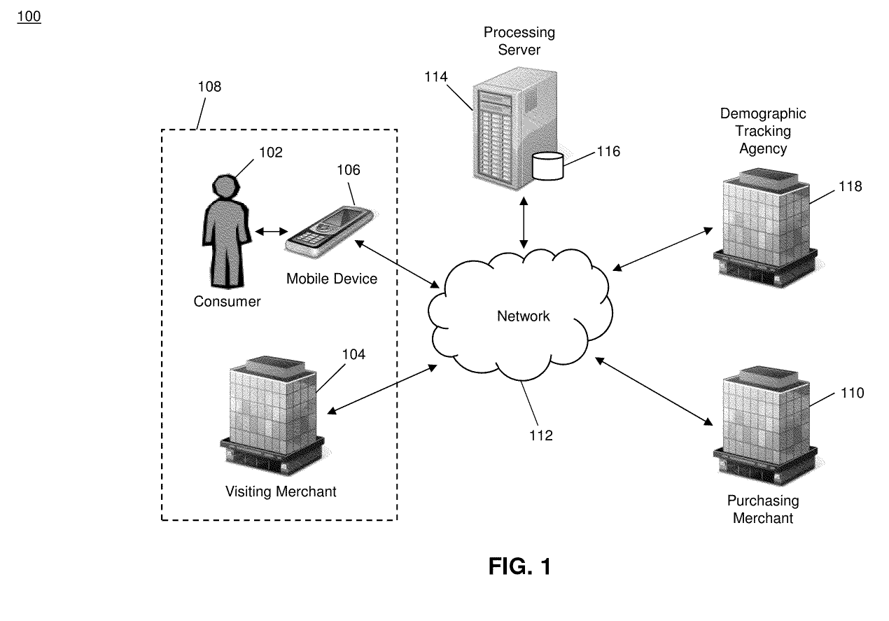

FIG. 1 illustrates a system 100 for identifying indications of showrooming and identifying the characteristics of showrooming consumers.

A consumer 102 may visit a physical location of a merchant 104, referred to herein as the visiting merchant 104. The visiting merchant 104 may offer a plurality of goods or services (e.g., products) for purchase. The consumer 102 may be in possession of a mobile device 106. The mobile device 106 may be any type of mobile communication device suitable for performing the functions as disclosed herein, such as a cellular phone, smart phone, tablet, etc.

The consumer 102 may be visiting the visiting merchant 104 in order to showroom a particular product the consumer 102 desires to purchase. After viewing the particular product, the consumer 102 may, using the mobile device 106, purchase the product in an e-commerce transaction from a purchasing merchant 110. The purchase may be made via a network 112, which may be any type of network suitable for performing the functions as discussed herein, such as the Internet.

The system 100 may further include a processing server 114, discussed in more detail below, configured to identify the e-commerce transaction involving the consumer 102 and the purchasing merchant 110 as a showrooming transaction. The processing server 114 may receive transaction data for the financial transaction from a payment network used to process the financial transaction, or from any other suitable source that will be apparent to persons having skill in the relevant art. The processing server 114 may also receive location information related to a geographic location of the mobile device 106, which may be received from a mobile communication network, service provider, or any other suitable source. Methods suitable for identifying the location of a mobile device will be apparent to persons having skill in the relevant art and may include application based tracking, Bluetooth, radio frequency identification, Wi-Fi, etc. The location and transaction data may be stored in one or more databases 116, discussed in more detail below.

The processing server 114 may identify the location of the mobile device 106 at the time of the financial transaction to be within a geographic area 108 corresponding to the visiting merchant 104. The processing server 114 may also identify that the financial transaction does not involve the visiting merchant 104, and thus identify the financial transaction as indicative of showrooming.

The processing server 114 may also receive demographic or other characteristic information associated with the consumer 102 from a third party, such as a demographic tracking agency 118. The demographic tracking agency 118 may include demographic information (e.g., age, gender, income, residential status, marital status, familial status, education, occupation, etc.) associated with the consumer 102. In an exemplary embodiment, the demographic tracking agency 118 may render the demographic information anonymous such that the information is not personally identifiable when transmitted to the processing server 114, such as by bucketing the information. In some embodiments, the processing server 114 may transmit a request for demographic information for a plurality of consumers (e.g., showroomers) and may receive, from the demographic tracking agency 118, summarized characteristic data such that none of the plurality of consumers is personally identifiable. Additional systems and methods for receiving characteristic information for one or more consumers that is not personally identifiable will be apparent to persons having skill in the relevant art.

The processing server 114 may aggregate the data regarding transactions indicative of showrooming and may transmit the aggregated data to the visiting merchant 104 (e.g., via the network 112). Information included in the aggregated data will be apparent to persons having skill in the relevant art, and may be dependent on the merchant, related products, or other similar information. For example, the visiting merchant 104 may request information regarding only showrooming transactions involving more than $200, may request information regarding only showrooming that occurred in their geographic area 108, or may request information regarding all showrooming-indicated transactions of merchants in a related merchant industry.

### Processing Server

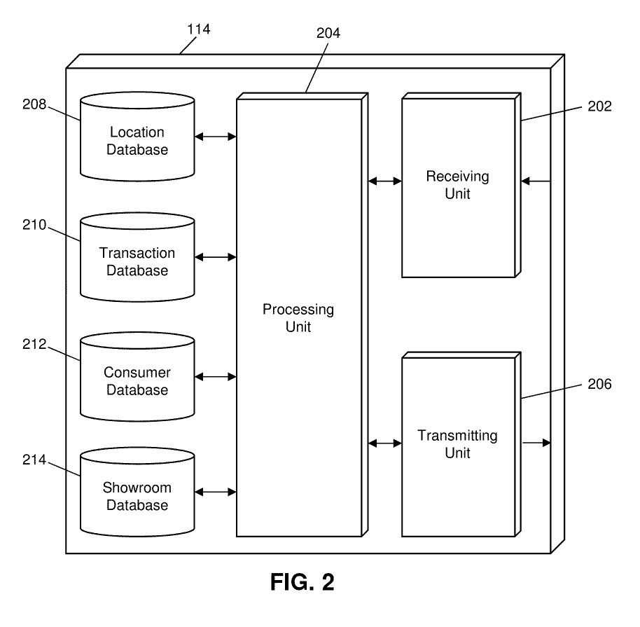

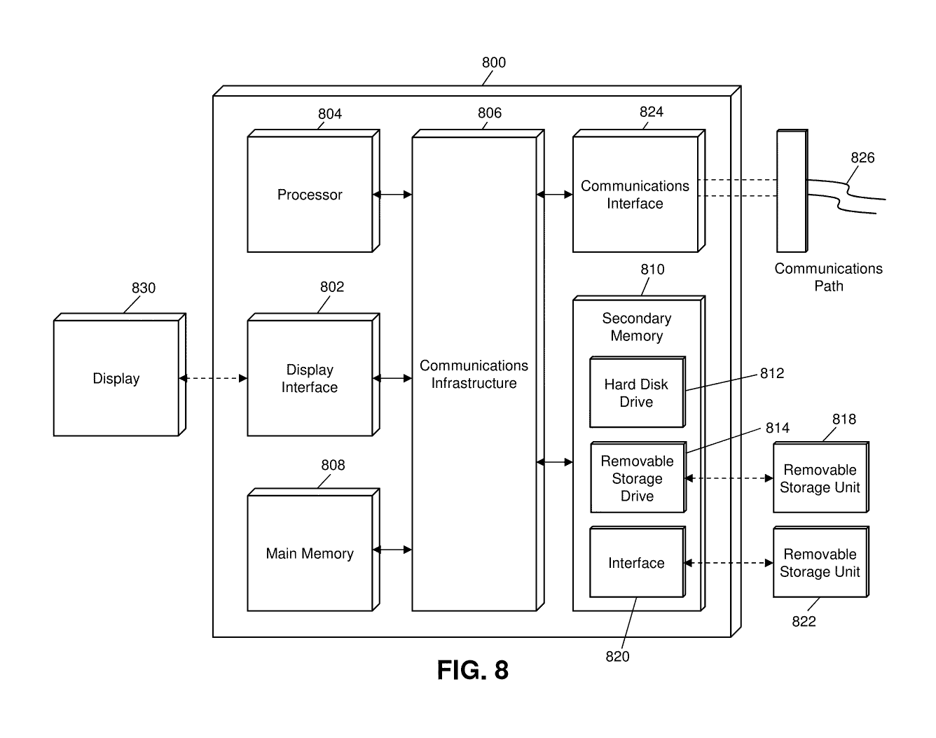

FIG. 2 illustrates an embodiment of the processing server 114 of the system 100. It will be apparent to persons having skill in the relevant art that the embodiment of the processing server 114 illustrated in FIG. 2 is provided as illustration only and may not be exhaustive to all possible configurations of the processing server 114 suitable for performing the functions as discussed herein. For example, the computer system 800 illustrated in FIG. 8 and discussed in more detail below may be a suitable configuration of the processing server 114.

The processing server 114 may include a receiving unit 202. The receiving unit 202 may be configured to receive data, such as transaction data, location data, characteristic data, etc. from one or more sources. The receiving unit 202 may be configured to communicate with one or more networks, such as the network 112, and via one or more protocols, as will be apparent to persons having skill in the relevant art. The receiving unit 202 may receive, for example, location information, which may be stored, by a processing unit 204, in a location database 208 of the processing server 114.

The location database 208 may be configured to store a plurality of location data entries. Each location data entry may include data related to a location of a mobile device (e.g., the mobile device 106) associated with a consumer (e.g., the consumer 102) including at least a geographic location and a location timestamp. The location timestamp may be the time and/or date when the mobile device 106 was identified as being at the geographic location.

The processing server 114 may also include a transaction database, discussed in more detail below. The transaction database may include data related to a financial transaction involving a consumer (e.g., the consumer 102), including at least a merchant identifier and a transaction timestamp. The merchant identifier, discussed in more detail below, may be associated with the purchasing merchant 110 involved in the financial transaction. The transaction timestamp may be the day and/or time when the financial transaction was conducted (e.g., initiated, processed, approved, cleared, etc.).

The processing unit 204 may be configured to identify at least one matched data entry for the consumer 102 where the location timestamp for a location data entry corresponds to the transaction timestamp for a transaction data entry. The processing unit 204 may then identify, based on the geographic location of the mobile device and the purchasing merchant 110, if the transaction is indicative of showrooming. For example, if the consumer 102 is located (e.g., based on their mobile device 106) to be at the visiting merchant 104 in one state, but conducts a financial transaction at the same time with the purchasing merchant 110 located in another state, the transaction may indicate showrooming by the consumer 102.

The processing unit 204 may store data related to the identified matched data entry in a showroom database 214. The showroom database 214 may be configured to store a plurality of data entries including data related to transactions indicative of showrooming. Information included in the showroom database 214 will be apparent to persons having skill in the relevant art.

The processing server 114 may also include a consumer database 212. The consumer database 212 may be configured to store characteristic data related to one or more consumers, such as demographic data. The receiving unit 202 may receive such characteristic data from one or more third parties, such as the demographic tracking agency 118. The processing unit 204 may then store the received characteristic data in the consumer database 212. The processing unit 204 may also be configured to aggregate characteristic data stored in the consumer database 212. The aggregated data may be based on identified data entries stored in the showroom database 214, as will be apparent to persons having skill in the relevant art. For example, the processing unit 204 may identify transactions indicative of showrooming in the showroom database 214 involving the visiting merchant 104 (e.g., where the mobile device 106 is located in the geographic area 108 at the time of the financial transaction), and may thus identify characteristic data for consumers involved in the identified transactions in the consumer database 212.

The processing unit 204 may be configured to generate a report based on the identified characteristic data, such as to provide the information in a format suitable for review by a requesting entity, such as the visiting merchant 104. The processing server 114 may include a transmitting unit 206, which may be configured to transmit the characteristic data and/or report (e.g., via the network 112), such as to the visiting merchant 104.

### Transaction Database

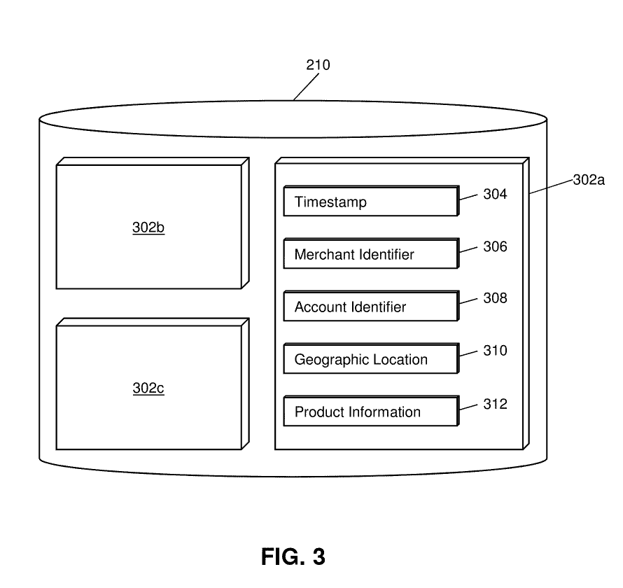

FIG. 3 illustrates the transaction database 210 of the processing server 114. The transaction database 210 may be configured to store a plurality of transaction data entries 302, illustrated in FIG. 3 as transaction data entries 302a, 302b, and 302c.

Each transaction data entry 302 may include data related to a financial transaction including at least a timestamp 304 and a merchant identifier 306. In some embodiments, each transaction data entry 302 may further include at least one of: an account identifier 308, a geographic location 310, and product information 312. The timestamp 304 may be a time and/or date at which the related financial transaction was conducted. The timestamp 304 may be represented in any format suitable for use as will be apparent to persons having skill in the relevant art.

The merchant identifier 306 may be a unique value associated with the purchasing merchant 110 involved in the financial transaction suitable for uniquely identifying the purchasing merchant 110. Values for use as the merchant identifier 306 will be apparent to persons having skill in the relevant art, and may include a merchant identification number (MID). The account identifier 308 may be a unique value associated with a payment account used to fund the financial transaction. The account identifier 308 may be the payment account number, or any other suitable value as will be apparent to persons having skill in the relevant art. The account identifier 308 may be suitable for use in identifying the consumer involved in the financial transaction in the consumer database 212 for the aggregation of characteristic data.

The geographic location 310 may be a location where the financial transaction was initiated and/or conducted. For example, the geographic location 310 may be a geographic location of the consumer 102, or of the purchasing merchant 110, at the time of (e.g., at initiating, processing, approval, finalization, etc.) the financial transaction. The geographic location 310 may be useful in identifying the related financial transaction as indicative of a showrooming transaction.

The product information 312 may be information related to one or more products (e.g., goods or services) purchased as part of the financial transaction. Product information 312 may include product identifiers (e.g., universal product codes, stock-keeping units, serial numbers, etc.), product names, product descriptions, product categories, product sizes, product colors, product quantities, etc., as will be apparent to persons having skill in the relevant art. The processing unit 204 may be configured to analyze the product information 312 as part of the aggregation of data for presentation to the visiting merchant 104 or other requesting entity. For example, the processing unit 204 may identify common product information of products purchased via showrooming.

### Method for Identifying Instances of Showrooming

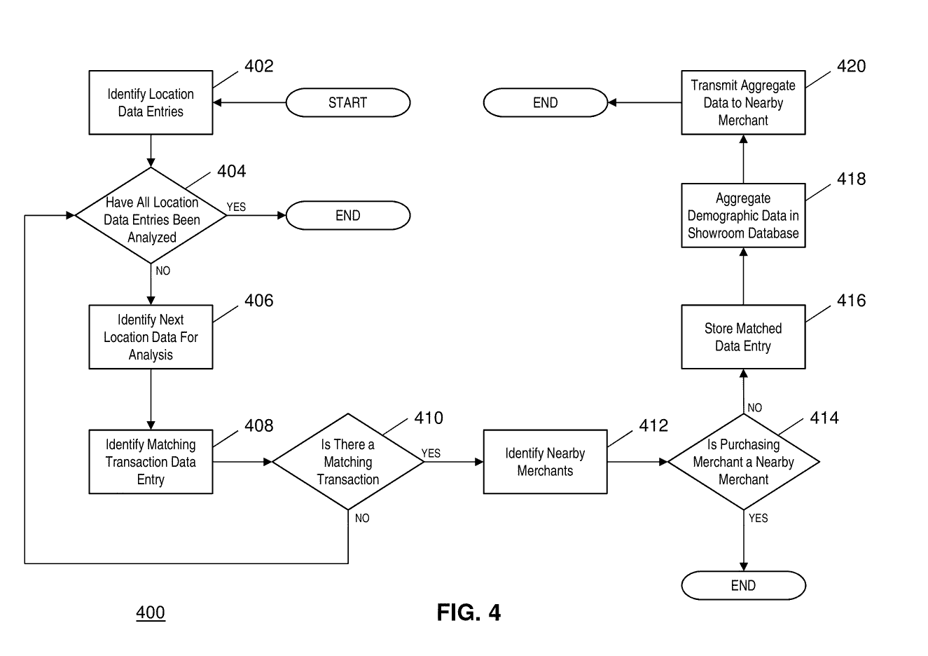

FIG. 4 illustrates a method 400 for the identification of instances of showrooming, and for the aggregation of characteristic data of showrooming consumers.

In step 402, the processing unit 204 may identify location data entries in the location database 208 to be analyzed. In step 404, the processing unit 204 may determine if all location data entries identified in the previous step had been analyzed. If all location data entries are already analyzed, then the method 400 may be completed. If there are location data entries remaining to be analyzed, then, in step 406, the processing unit 204 may identify the next location data entry in the location database 208 for analysis.

In step 408, the processing unit 204 may identify, in the transaction database 210, if there are any transaction data entries 302 including a transaction timestamp 304 corresponding to the location timestamp in the identified location data entry. It will be apparent to persons having skill in the relevant art that steps 402-408 may be modified such that transaction data entries are identified first, and then a matching location data entry identified, as opposed to first identifying the location data entries. In exemplary embodiments, steps 402-408 may include matching of location data entries and transaction data entries 302 corresponding to a single consumer 102. The identification of location data entries for a single consumer 102 may be based on the mobile device 106 associated with the consumer 102. Methods and systems for identifying a relationship between a consumer 102 and a mobile device 106 are described in further detail in U.S. patent application Ser. No. 13/457,701, filed on Apr. 27, 2012, for “Method for Providing Payment Card Using Registrationless Telecom Geolocation Capture” and U.S. patent application Ser. No. 13/671,791, filed on Nov. 8, 2012, for “Methods for Geotemporal Fingerprinting”, which are herein incorporated by reference in their entirety. In step 410, the processing unit 204 may determine if any matching transaction data entries 302 were identified. If no matching entries 302 were identified, then the method may return to step 404.

If a matching transaction data entry 302 is identified, then, in step 412, the processing unit 204 may identify merchants nearby the geographic location of the mobile device 106 as indicated in the identified location data entry in the location database 208. In step 414, the processing unit 204 may identify if the purchasing merchant 110 involved in the financial transaction related to the matched transaction data entry 302 (e.g., based on the merchant identifier 306) is included in the identified nearby merchants. If the purchasing merchant 110 is nearby to the geographic location, then the method 400 may be completed as it indicates that the consumer 102 was at the physical location of the purchasing merchant 110.

If, on the other hand, the purchasing merchant 110 is not nearby to the geographic location, then, in step 416, the processing unit 204 may store a matched data entry related to the matched transaction data entry 302 and identified location data entry in the showroom database 214. In some embodiments, the method 400 may return to step 404 to continue to analyze all location data entries (e.g., or transaction data entries 302) prior to continue on to step 418. In other embodiments, the method 400 may wait until a request for characteristic data is received (e.g., by the receiving unit 202) by the processing server 114.

In step 418, the processing unit 204 may aggregate demographic or other characteristic data in the consumer database 212 associated with the matched data entries stored in the showroom database 214. In some embodiments, the processing unit 204 may aggregate data included in the matched data entries themselves (e.g., the product information 312), or may aggregate only data indicated in a received request for characteristic data. In step 420, the transmitting unit 206 may transmit the aggregated data to one or more of the identified nearby merchants, such as the visiting merchant 104. In another embodiment, the transmitting unit 206 may transmit the aggregated data in response to a received request for characteristic data.

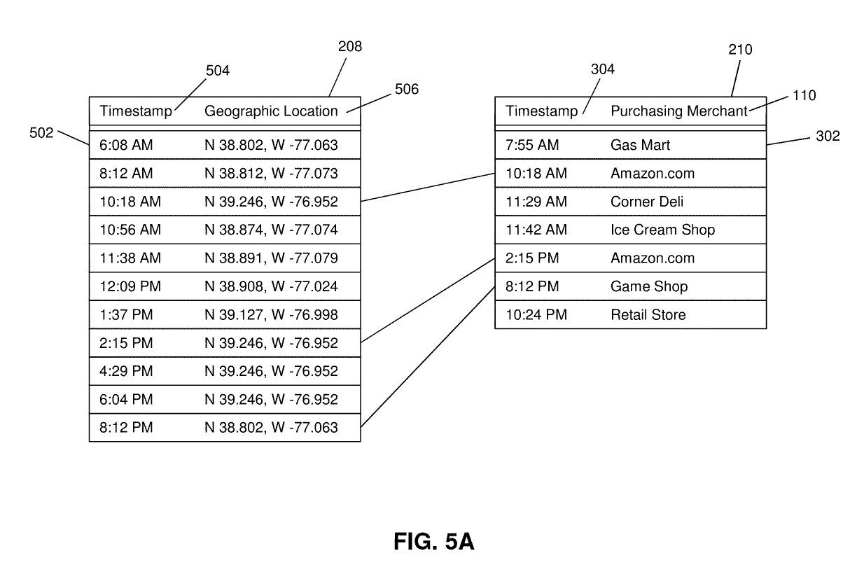

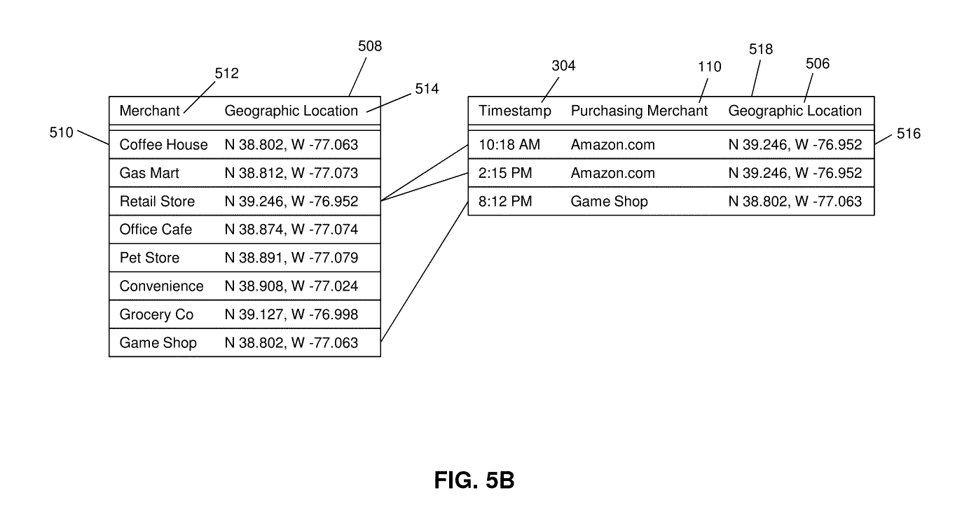

FIGS. 5A and 5B illustrate data entries that may be included in the location database 208 and the transaction database 210 and the identification of matched data entries based therefrom.

FIG. 5A illustrates a plurality of location data entries 502 included in the location database 208. Each location data entry 502 may include a timestamp 504 and a geographic location 506. In the illustrated embodiment, the geographic location 506 may be represented via latitude and longitude. FIG. 5A also illustrates a plurality of transaction data entries 302 included in the transaction database 210, including a transaction timestamp 304 and the purchasing merchant 110 (e.g., associated with the merchant identifier 306 included in the corresponding transaction data entry 302).

The processing unit 204 may, for each location data entry 502 in the location database 208, identify any transaction data entry 302 where the location timestamp 504 corresponds to the transaction timestamp 304. In the example illustrated in FIG. 5A, the processing unit 204 may identify three pairs of matched data entries, where transactions took place with a saved geographic location at 10:18 AM, 2:15 PM, and 8:12 PM. As discussed above, in an exemplary embodiment, the location data entries 502 and transaction data entries 302 may be identified for comparison as associated with a single consumer 102.

With reference to FIG. 5B, for each matched data entry 516 of the identified matched data entries 518, the processing unit 204 may identify at least one nearby merchant based on the geographic location 506 for each location data entry 502 in the matched data entry. Table 508 of FIG. 5B illustrates a plurality of merchant data entries 510 including at least a merchant 512 and a corresponding geographic location 514. FIG. 5B also illustrates the showroom database 214 including the three identified matched data entries 516. In the example illustrated in FIG. 5B, the processing unit 204 may identify a nearby merchant (e.g., the visiting merchant 104) for each identified transaction data entry 302 matched to a location data entry 502. The processing unit 204 may then identify if the identified nearby merchant 512 for each of the matched data entries 516 corresponds to the purchasing merchant 110 involved in the financial transaction.

In the example illustrated in FIG. 5B, at the time of the financial transactions conducted at 10:18 AM and 2:15 PM, the mobile device 106 of the consumer 102 was located at a geographic location corresponding to Retail Store, while the financial transaction involved a different merchant, Amazon.com. The processing unit 204 may thus identify those two transactions as indicative of showrooming, where the consumer 102 visited the visiting merchant 104 of Retail Store, but then, while still at Retail Store, used their mobile device 106 to purchase presumably previewed products from Amazon.com. During the transaction that was conducted with Game Shop at 8:12 PM, the mobile device 106 of the consumer 102 was identified at a location corresponding to Game Shop, and thus would be determined as not indicative of showrooming. The processing unit 204 may then store the matched data entries 516 for the two transactions identified as being indicative of showrooming into the showroom database 214.

### Exemplary Method for Identifying Instances of Showrooming

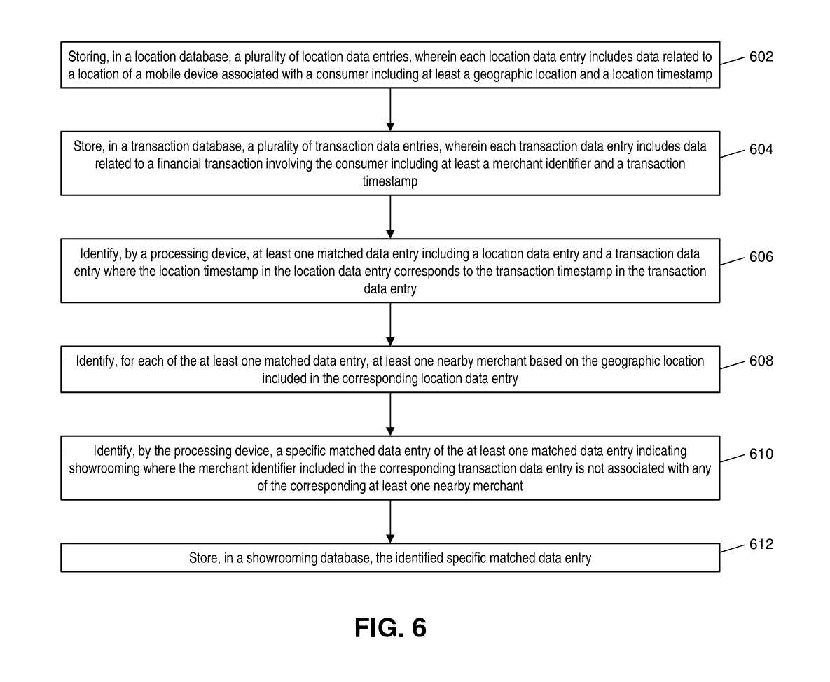

FIG. 6 illustrates a method for identifying instances of showrooming.

In step 602, a plurality of location data entries may be stored in a location database (e.g., the location database 208), wherein each location data entry includes data related to a location of a mobile device (e.g., the mobile device 106) associated with a consumer (e.g., the consumer 102) including at least a geographic location and a location timestamp. In step 604, a plurality of transaction data entries (e.g., transaction data entries 302) may be stored in a transaction database (e.g., the transaction database 210), wherein each transaction data entry 302 includes data related to a financial transaction involving the consumer 102 and including at least a merchant identifier (e.g., the merchant identifier 306) and a transaction timestamp (e.g., the timestamp 304).

In step 606, a processing device (e.g., the processing unit 204) may identify at least one matched data entry including a location data entry and a transaction data entry 302 where the location timestamp in the location data entry corresponds to the transaction timestamp 304 in the transaction data entry 302. In step 608, at least one nearby merchant may be identified, for each of the at least one matched data entry 516, based on the geographic location included in the corresponding location data entry. In one embodiment, identifying at least one nearby merchant may include identifying, for each of the at least one nearby merchant, the geographic location included in the corresponding location data entry as being inside of a predefined geographical area (e.g., the geographical area 108) associated with the corresponding at least one merchant.

In step 610, the processing device 204 may identify a specific matched data entry of the at least one matched data entry 516 indicating showrooming where the merchant identifier 306 included in the corresponding transaction data entry 302 is not associated with any of the corresponding at least one merchant. In step 612, the identified specific matched data entry may be stored in a showrooming database (e.g., the showroom database 214).

In one embodiment, the method may further comprise transmitting, by a transmitting device (e.g., the transmitting unit 206), the specific matched data entry to the at least one nearby merchant. In another embodiment, the method may further comprise identifying, by the processing device 204, a subset of specific matched data entries stored in the showrooming database 214 with a common geographic location included in the corresponding location data entries, and transmitting, by the transmitting device 206, data related to the identified subset of specific matched data entries to the at least one nearby merchant. In a further embodiment, the data related to the identified subset of specific matched data entries includes at least one merchant associated with the merchant identifier 306 included in each of the corresponding transaction data entries 302.

In another embodiment, each transaction data entry 302 may further include product information (e.g., the product information 312) corresponding to goods and/or services purchased in the related financial transaction, and the method may further include transmitting, by the transmitting device 206, the product information 312 in the transaction data entry 302 of the specific matched data entry to the at least one nearby merchant. In yet another embodiment, the method may further include: receiving, by a receiving device (e.g., the receiving unit 202), demographic information associated with the consumer 102; and associating, in the showrooming database 214, the received demographic information with the specific matched data entry, wherein the received demographic information does not include any personally identifiable information.

### Exemplary Method for Identifying Characteristics of Showrooming Consumers

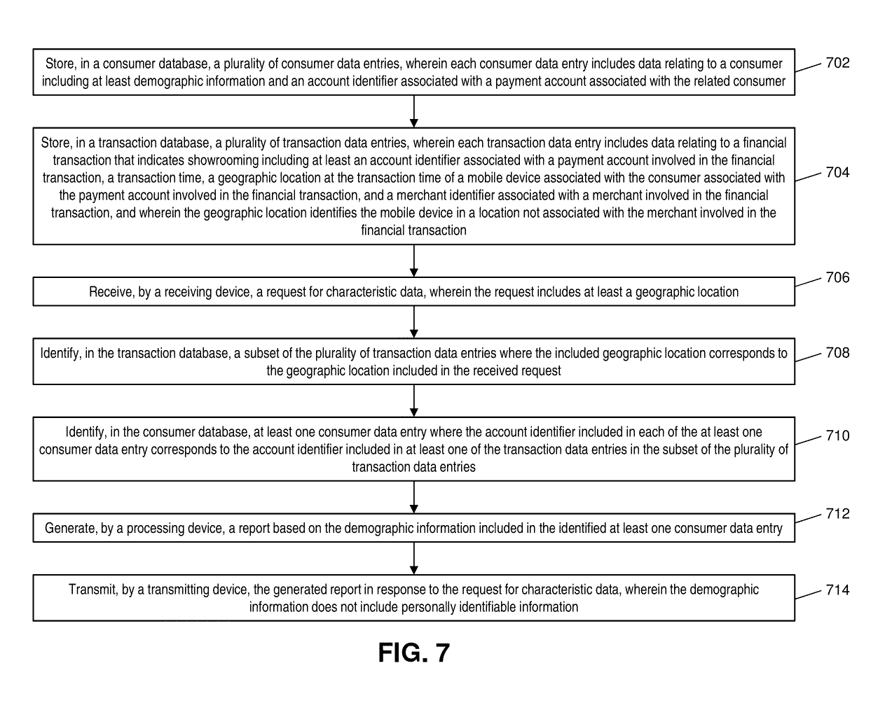

FIG. 7 illustrates a method for identifying characteristics of showrooming consumers.

In step 702, a plurality of consumer data entries may be stored in a consumer database (e.g., the consumer database 212), wherein each consumer data entry includes data relating to a consumer (e.g., the consumer 102) including at least demographic information and an account identifier associated with a payment account associated with the related consumer 102. In step 704, a plurality of transaction data entries (e.g., the transaction data entries 302) may be stored in a transaction database (e.g., the transaction database 210), wherein each transaction data entry 302 includes data relating to a financial transaction that indicates showrooming including at least an account identifier (e.g., the account identifier 308) associated with a payment account involved in the financial transaction, a transaction time (e.g., the timestamp 304), a geographic location (e.g., the geographic location 310) at the transaction time 304 of a mobile device (e.g., the mobile device 106) associated with the consumer 102 associated with the payment account involved in the financial transaction, and a merchant identifier (e.g., the merchant identifier 306), associated with a merchant (e.g., the purchasing merchant 110) involved in the financial transaction, and wherein the geographic location 310 identifies the mobile device 106 in a location not associated with the merchant 110 involved in the financial transaction.

In step 706, a receiving device (e.g., the receiving unit 202), may receive a request for characteristic data, wherein the request includes at least a geographic location. In step 708, a subset of the plurality of transaction data entries may be identified, in the transaction database 210, where the included geographic location 310 corresponds to the geographic location included in the received request. In step 710, at least one consumer data entry may be identified, in the consumer database 212, where the account identifier included in each of the at least one consumer data entry corresponds to the account identifier 308 included in at least one of the transaction data entries 302 in the subset of the plurality of transaction data entries.

In step 712, a report may be generated, by a processing device (e.g., the processing unit 204), based on the demographic information included in the identified at least one consumer data entry. In one embodiment, the report may be further based on the merchants associated with the merchant identifier included in each transaction data entry 302 of the subset of transaction data entries. In another embodiment, each transaction data entry 302 may further include product information (e.g., the product information 312) corresponding to goods and/or services purchased in the related financial transaction, and the report may be further based on the product information 312 included in each transaction data entry 302 of the subset of transaction data entries.

In step 714, a transmitting device (e.g., the transmitting unit 206) may transmit the generated report in response to the request for characteristic data, wherein the demographic information used to generate the report does not include personally identifiable information.

### Computer System Architecture

FIG. 8 illustrates a computer system 800 in which embodiments of the present disclosure, or portions thereof, may be implemented as computer-readable code. For example, the processing server 114 of FIG. 1 may be implemented in the computer system 800 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 4, 6, and 7.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 818, a removable storage unit 822, and a hard disk installed in hard disk drive 812.

Various embodiments of the present disclosure are described in terms of this example computer system 800. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 804 may be a special purpose or a general purpose processor device. The processor device 804 may be connected to a communication infrastructure 806, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 800 may also include a main memory 808 (e.g., random access memory, read-only memory, etc.), and may also include a secondary memory 810. The secondary memory 810 may include the hard disk drive 812 and a removable storage drive 814, such as a floppy disk drive, a magnetic tape drive, an optical disk drive, a flash memory, etc.

The removable storage drive 814 may read from and/or write to the removable storage unit 818 in a well-known manner. The removable storage unit 818 may include a removable storage media that may be read by and written to by the removable storage drive 814. For example, if the removable storage drive 814 is a floppy disk drive, the removable storage unit 818 may be a floppy disk. In one embodiment, the removable storage unit 818 may be non-transitory computer readable recording media.

In some embodiments, the secondary memory 810 may include alternative means for allowing computer programs or other instructions to be loaded into the computer system 800, for example, the removable storage unit 822 and an interface 820. Examples of such means may include a program cartridge and cartridge interface (e.g., as found in video game systems), a removable memory chip (e.g., EEPROM, PROM, etc.) and associated socket, and other removable storage units 822 and interfaces 820 as will be apparent to persons having skill in the relevant art.

Data stored in the computer system 800 (e.g., in the main memory 808 and/or the secondary memory 810) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 800 may also include a communications interface 824. The communications interface 824 may be configured to allow software and data to be transferred between the computer system 800 and external devices. Exemplary communications interfaces 824 may include a modem, a network interface (e.g., an Ethernet card), a communications port, a PCMCIA slot and card, etc. Software and data transferred via the communications interface 824 may be in the form of signals, which may be electronic, electromagnetic, optical, or other signals as will be apparent to persons having skill in the relevant art. The signals may travel via a communications path 826, which may be configured to carry the signals and may be implemented using wire, cable, fiber optics, a phone line, a cellular phone link, a radio frequency link, etc.

Computer program medium and computer usable medium may refer to memories, such as the main memory 808 and secondary memory 810, which may be memory semiconductors (e.g. DRAMs, etc.). These computer program products may be means for providing software to the computer system 800. Computer programs (e.g., computer control logic) may be stored in the main memory 808 and/or the secondary memory 810. Computer programs may also be received via the communications interface 824. Such computer programs, when executed, may enable computer system 800 to implement the present methods as discussed herein. In particular, the computer programs, when executed, may enable processor device 804 to implement the methods illustrated by FIGS. 4, 6, and 7, as discussed herein. Accordingly, such computer programs may represent controllers of the computer system 800. Where the present disclosure is implemented using software, the software may be stored in a computer program product and loaded into the computer system 800 using the removable storage drive 814, interface 820, and hard disk drive 812, or communications interface 824.

Techniques consistent with the present disclosure provide, among other features, systems and methods for identifying instances of showrooming and for identifying characteristics of showrooming consumers. While various exemplary embodiments of the disclosed system and method have been described above, it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for identifying instances of showrooming, comprising:
storing, in a location database, a plurality of location data entries, wherein each location data entry includes data related to a location of a mobile device associated with a consumer including at least a geographic location and a location timestamp;
storing, in a transaction database, a plurality of transaction data entries, wherein each transaction data entry includes data related to a financial transaction involving the consumer including at least a merchant identifier and a transaction timestamp;
identifying, by a processing device, at least one matched data entry including a location data entry and a transaction data entry where the location timestamp in the location data entry is within a predefined range of time that includes the transaction timestamp in the transaction data entry;
identifying, for each of the at least one matched data entry, at least one nearby merchant based on the geographic location included in the corresponding location data entry;
identifying, by the processing device, a specific matched data entry of the at least one matched data entry indicating showrooming where the merchant identifier included in the corresponding transaction data entry is not associated with any of the corresponding at least one nearby merchant; and
storing, in a showrooming database, the identified specific matched data entry.

2. The method of claim 1, further comprising:
aggregating a plurality of specific matching data entries, the number of which assures no individual can be specifically identified from the aggregated data; and
transmitting, by a transmitting device, the aggregated data to the at least one nearby merchant.

3. The method of claim 1, further comprising:
identifying, by the processing device, a subset of specific matched data entries stored in the showrooming database with a common geographic location included in the corresponding location data entries; and
transmitting, by a transmitting device, data related to the identified subset of specific matched data entries to the at least one nearby merchant.

4. The method of claim 3, wherein the data related to the identified subset of specific matched data entries includes at least one merchant associated with the merchant identifier included in each of the corresponding transaction data entries.

5. The method of claim 1, wherein each transaction data entry further includes product information corresponding to goods and/or services purchased in the related financial transaction, and the method further comprises:
transmitting, by a transmitting device, the product information included in the transaction data entry of the specific matched data entry to the at least one nearby merchant.

6. The method of claim 1, further comprising:
receiving, by a receiving device, demographic information associated with the consumer; and
associating, in the showrooming database, the received demographic information with the specific matched data entry, wherein the received demographic information does not include any personally identifiable information.

7. The method of claim 1, wherein identifying at least one nearby merchant includes identifying, for each of the at least one nearby merchant, the geographic location included in the corresponding location data entry as being inside of a predefined geographical area associated with the corresponding at least one nearby merchant.

8. A method for identifying characteristics of showrooming consumers, comprising:
storing, in a consumer database, a plurality of consumer data entries, wherein each consumer data entry includes data relating to a consumer including at least demographic information and an account identifier associated with a payment account associated with the related consumer;
storing, in a transaction database, a plurality of transaction data entries, wherein each transaction data entry includes data relating to a financial transaction that indicates showrooming including at least an account identifier associated with a payment account involved in the financial transaction, a transaction time, a geographic location at the transaction time of a mobile device associated with the consumer associated with the payment account involved in the financial transaction, and a merchant identifier associated with a merchant involved in the financial transaction, and wherein the geographic location identifies the mobile device in a location not associated with the merchant involved in the financial transaction;
receiving, by a receiving device, a request for characteristic data, wherein the request includes at least a geographic location;
identifying, in the transaction database, a subset of the plurality of transaction data entries where the included geographic location corresponds to the geographic location included in the received request;
identifying, in the consumer database, at least one consumer data entry where the account identifier included in each of the at least one consumer data entry corresponds to the account identifier included in at least one of the transaction data entries in the subset of the plurality of transaction data entries;
generating, by a processing device, a report based on the demographic information included in the identified at least one consumer data entry; and
transmitting, by a transmitting device, the generated report in response to the request for characteristic data, wherein
the demographic information does not include personally identifiable information.

9. The method of claim 8, wherein the generated report is further based on the merchants associated with the merchant identifier included in each transaction data entry of the subset of transaction data entries.

10. The method of claim 8, wherein each transaction data entry further includes product information corresponding to goods and/or services purchased in the related financial transaction, and the generated report is further based on the product information included in each transaction data entry of the subset of transaction data entries.

11. A system for identifying instances of showrooming, comprising:
a showroom database;
a location database configured to store a plurality of location data entries, wherein each location data entry includes data related to a location of a mobile device associated with a consumer including at least a geographic location and a location timestamp;
a transaction database configured to store a plurality of transaction data entries, wherein each transaction data entry includes data related to a financial transaction involving the consumer including at least a merchant identifier and a transaction timestamp; and
a processing device configured to
identify at least one matched data entry including a location data entry and a transaction data entry where the location timestamp in the location data entry is within a predetermined range of time that includes the transaction timestamp in the transaction data entry,
identify, for each of the at least one matched data entry, at least one nearby merchant based on the geographic location included in the corresponding location data entry,
identify a specific matched data entry of the at least one matched data entry indicating showrooming where the merchant identifier included in the corresponding transaction data entry is not associated with any of the corresponding at least one nearby merchant, and
store, in the showrooming database, the identified specific matched data entry.

12. The system of claim 11, wherein
the processing device is further configured to aggregate a plurality of specific matching data entries, the number of which assures no individual can be specifically identified from the aggregated data, and the system further comprises:
a transmitting device configured to transmit the specific matched data entry to the at least one nearby merchant.

13. The system of claim 11, wherein
the processing device is further configured to identify a subset of specific matched data entries stored in the showrooming database with a common geographic location included in the corresponding location data entries, and the system further comprises:
a transmitting device configured to transmit data related to the identified subset of specific matched data entries to the at least one nearby merchant.

14. The system of claim 13, wherein the data related to the identified subset of specific matched data entries includes at least one merchant associated with the merchant identifier included in each of the corresponding transaction data entries.

15. The system of claim 11, wherein each transaction data entry further includes product information corresponding to goods and/or services purchased in the related financial transaction, and the system further comprises:
a transmitting device configured to transmit the product information included in the transaction data entry of the specific matched data entry to the at least one nearby merchant.

16. The system of claim 11, further comprising:
a receiving device configured to receive demographic information associated with the consumer, wherein
the processing device is further configured to associate, in the showrooming database, the received demographic information with the specific matched data entry, and
the received demographic information does not include any personally identifiable information.

17. The system of claim 11, wherein identifying at least one nearby merchant includes identifying, for each of the at least one nearby merchant, the geographic location included in the corresponding location data entry as being inside of a predefined geographical area associated with the corresponding at least one nearby merchant.

18. A system for identifying characteristics of showrooming consumers, comprising:
a consumer database configured to store a plurality of consumer data entries, wherein each consumer data entry includes data relating to a consumer including at least demographic information and an account identifier associated with a payment account associated with the related consumer;
a transaction database configured to store a plurality of transaction data entries, wherein each transaction data entry includes data relating to a financial transaction that indicates showrooming including at least an account identifier associated with a payment account involved in the financial transaction, a transaction time, a geographic location at the transaction time of a mobile device associated with the consumer associated with the payment account involved in the financial transaction, and a merchant identifier associated with a merchant involved in the financial transaction, and wherein the geographic location identifies the mobile device in a location not associated with the merchant involved in the financial transaction;
a receiving device configured to receive a request for characteristic data, wherein the request includes at least a geographic location;
a processing device configured to
identify, in the transaction database, a subset of the plurality of transaction data entries where the included geographic location corresponds to the geographic location included in the received request,
identify, in the consumer database, at least one consumer data entry where the account identifier included in each of the at least one consumer data entry corresponds to the account identifier included in at least one of the transaction data entries in the subset of the plurality of transaction data entries, and
generate a report based on the demographic information included in the identified at least one consumer data entry; and
a transmitting device configured to transmit the generated report in response to the request for characteristic data, wherein
the demographic information does not include personally identifiable information.

19. The system of claim 18, wherein the generated report is further based on the merchants associated with the merchant identifier included in each transaction data entry of the subset of transaction data entries.

20. The system of claim 18, wherein each transaction data entry further includes product information corresponding to goods and/or services purchased in the related financial transaction, and the generated report is further based on the product information included in each transaction data entry of the subset of transaction data entries.
